(19) United States
(12) Patent Application Publication
(10) Pub. No.: US 2017/0370447 A1
(43) Pub. Date: Dec. 28, 2017

(54) HYDRAULIC TENSIONER WITH CANTILEVER SHIPPING SPRING

(71) Applicant: BorgWarner Inc., Auburn Hills, MI (US)

(72) Inventors: Paul FREEMANTLE, Lansing, NY (US); Robert G. WILLIAMSON, Breesport, NY (US); J. Christian HAESLOOP, Ithaca, NY (US)

(21) Appl. No.: 15/539,889

(22) PCT Filed: Dec. 14, 2015
(86) PCT No.: PCT/US2015/065464

§ 371 Date: Jun. 26, 2017

Related U.S. Application Data
(60) Provisional application No. 62/097,167, filed on Dec. 29, 2014.

(51) Int. Cl. F16H 7/08

(52) U.S. Cl. CPC F16H 7/0848; F16H 2007/0878; F16H 2007/0806; F16H 2007/0812; F16H 2007/0859

(57) ABSTRACT

A hydraulic tensioner (10) and method of assembly can include a housing (12) having an aperture and a piston (16) received within the aperture for movement between an extended position and a retracted position. A tensioner spring (36) positioned within the aperture for bias the piston (16) toward the extended position. The piston (16) and the aperture of the housing (12) defining an expandable fluid chamber (18). The hydraulic tensioner (10) can include a cantilever spring (20) having a first end (22) attachable to the housing (12) and a second end (24) releasably engageable with the piston (16) for retaining the piston (16) in the retracted position against urging of the tensioner spring (36) during storage, shipment, installation, and service. The second end (24) can be disengageable from the piston (16) allowing movement of the piston (16) outwardly toward the extended position during operation in a working environment.

### FIELD OF THE INVENTION

The invention relates to a hydraulic chain tensioner having a piston longitudinally movable in a cylindrical aperture of the tensioner, and more particularly to a securing feature for holding the piston assembled internally within the cylindrical aperture of the hydraulic tensioner during shipping, installation and service.

### BACKGROUND

There is a desire to provide a cost-effective piston securing feature in order to avoid disassembly of parts during shipping and installation of a hydraulic tensioner, and to further allow resetting the piston during a service situation.

### SUMMARY

A hydraulic tensioner for an endless loop power transmission member can include a housing having a cylindrical aperture and a piston slidably received within the cylindrical aperture for movement between an extended position and a retracted position. A tensioner spring can bias the piston outwardly from the cylindrical aperture toward the extended position. The piston and the cylindrical aperture can define an expandable fluid chamber. The hydraulic tensioner can include a cantilever spring having a first end attachable to the housing and a second end releasably engageable with the piston for retaining the piston in the retracted position within the cylindrical aperture of the hydraulic tensioner against urging of the tensioner spring during shipment and installation. The second end of the cantilever spring can be disengageable from the piston allowing movement of the piston outwardly toward the extended position with respect to the cylindrical aperture of the housing after installation to enable operation of the hydraulic tensioner.

A hydraulic tensioner can include a housing having a longitudinal cylindrical aperture and defining a fluid passage in fluid communication with an interior of the cylindrical aperture. The hydraulic tensioner can include a piston received in the cylindrical aperture for longitudinal movement between an extended position and a retracted position. A tensioner spring can be positioned within the cylindrical aperture to bias the piston toward the extended position with respect to the cylindrical aperture. A cantilever spring can be attachable to the housing at one end with a free end for retaining the piston within the cylindrical aperture of the housing. The piston and the cylindrical aperture of the housing can define a fluid chamber between the housing and the piston. The piston can have a spring-retention groove formed on a nose end of the piston. The cantilever spring can have a first end attachable to the housing and a second end releasably engageable with the spring retention groove of the piston for retaining the piston within the cylindrical aperture of the hydraulic tensioner during shipment and installation. The second end of the cantilever spring can be disengageable with the spring retention groove allowing longitudinal movement of the piston outwardly with respect to the housing to enable operation of the hydraulic tensioner.

A hydraulic tensioner can be assembled for an endless loop power transmission member. The hydraulic tensioner can have a housing having a cylindrical aperture. The method can include inserting a tensioner spring into the cylindrical aperture, inserting a slideable tensioning piston into the cylindrical aperture for movement between an extended position and a retracted position, and attaching a cantilever spring to the housing. A fluid chamber can be defined between the cylindrical aperture of the housing and the piston. The tensioner spring can bias the piston outwardly with respect to the cylindrical aperture of the housing. The cantilever spring can have a first end attachable to the housing and a second end releasably engageable with the piston for retaining the piston within the hydraulic tensioner against urgings of the tensioner spring during storage, shipment and installation. The second end of the cantilever spring can be disengageable with the piston allowing movement of the piston outwardly with respect to the housing to enable operation of the hydraulic tensioner.

### BRIEF DESCRIPTION OF THE DRAWINGS

The description herein makes reference to the accompanying drawings wherein like reference numerals refer to like parts throughout the several views, and wherein:

FIG. 1 is a cross sectional view of a hydraulic tensioner having a housing defining a cylindrical aperture with a piston slidably received with the cylindrical aperture of a housing for movement between an extended position and a retracted position, a spring biasing the piston toward the extended position with respect to the cylindrical aperture, and a cantilever spring having a first end attachable to the housing and a second end releasably engageable with the piston for retaining the piston in the retracted position within the cylindrical aperture against urgings of the spring during storage, shipment and installation;

FIG. 2 is a top view of the hydraulic tensioner of FIG. 1 showing a spring-retention groove formed on a nose end of the piston and the second end of the cantilever spring engageable with the spring-retention groove securing the cantilever spring to the nose end of the piston and retaining the piston within the cylindrical aperture of the housing against the urging of the tensioner spring;

FIG. 3 is a perspective view of the hydraulic tensioner of FIG. 1 showing a hooked end formed at the second of the cantilever spring engageable with the spring-retention groove and a spring-receiving slot formed in the housing fixedly receiving the first end of the cantilever spring; and

FIG. 4 is an exploded view of the hydraulic tensioner of FIG. 1.

### DETAILED DESCRIPTION

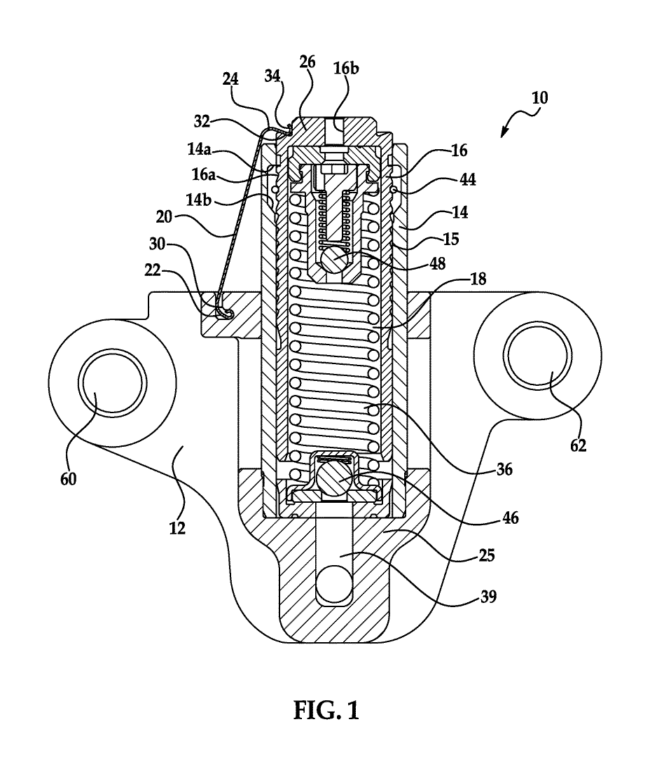

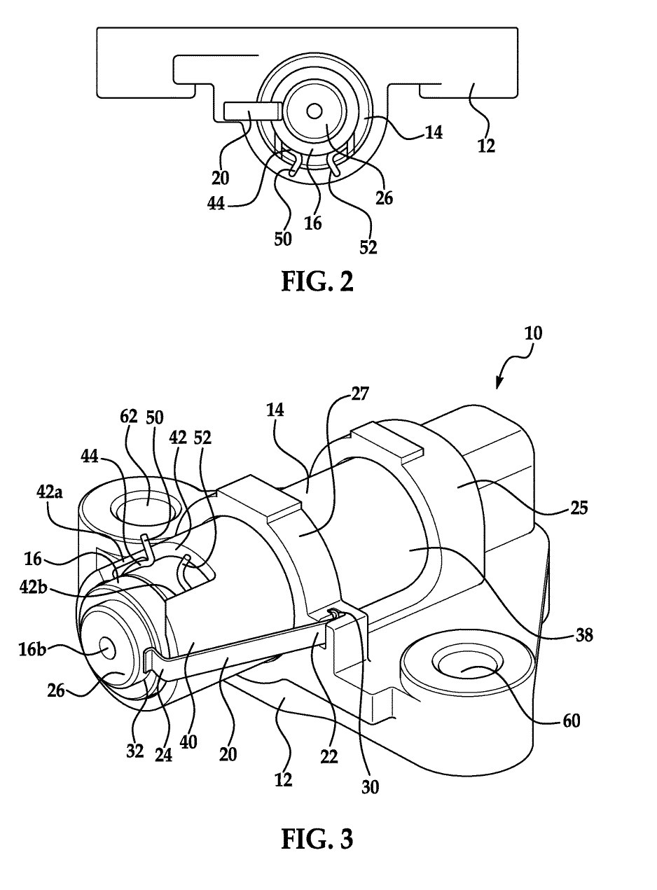

Referring now to FIGS. 1-4, a tensioning system for imparting tension to an endless loop power transmission member can include a hydraulic tensioner 10. By way of example and not limitation, the endless loop power transmission member can include a chain or a belt encircling a driving sprocket and at least one driven sprocket. The hydraulic tensioner 10 can include a housing 12 supporting a hollow longitudinal sleeve 14 defining an interior aperture. The interior aperture can be a cylindrical aperture and a slideable piston 16 can be slidably received within the cylindrical aperture within sleeve 14 for longitudinal movement between an extended position and a retracted position, and a tensioner spring 36 biasing the piston 16 toward the extended position with respect to the cylindrical aperture 14. The piston 16 and the cylindrical aperture 15 can define an expandable fluid chamber 18. In operation, fluid enters the fluid chamber 18 through a fluid passage 39 formed in the housing 12 from a source of pressurized fluid, such as an oil pump or reservoir. The hydraulic tensioner 10 can include a cantilever spring 20 having a first end 22 attachable to the housing 12 and a second end 24 releasably engageable with the piston 16 for retaining the piston 16 in the retracted position within the cylindrical aperture 15 of the hydraulic tensioner 10 against urgings of the biasing spring 36 during storage, shipment and installation. The second end 24 can be disengageable from the piston 16 to allow longitudinal movement of the piston 16 outwardly toward the extended position with respect to the cylindrical aperture 15 of the housing 12. The second end 24 of the cantilever spring 20 can be re-engaged with an outer end of the piston 16 for retaining the piston 16 within the cylindrical aperture of the housing during service situations, by way of example and not limitation, such as service situations requiring repair, replacement, or adjustment of the endless loop power transmission member.

As best shown in FIGS. 1 and 3, by way of example and not limitation, the hydraulic tensioner 10 can include a spring-receiving slot 30 formed in the housing 12 of the hydraulic tensioner 10 for receiving the first end 22 of the cantilever spring 20. The cantilever spring 20 can be retained by the housing during both shipment and operation of the hydraulic tensioner 10, if desired. Alternatively, the cantilever spring 20 can be releasably engaged and disengaged with respect to retaining notches at both ends for separation from the housing 12, if desired. The spring-receiving slot 30 can include a hook-shaped slot formed in the housing 12. The first end 22 of the cantilever spring 20 can include a shaped end complementary to the shape of the spring-receiving slot 30 such that the first end 22 can be fixedly secured within the spring-receiving slot 30. By way of example and not limitation, the spring-receiving slot 30 can be located on the housing 12 along a surface adjacent to an outwardly extending nose end 26 of the piston 16. The second end 24 of the cantilever spring 20 can move relative to the fixed first end 22. As best shown in FIGS. 1-3, a spring-retention groove 32 can be formed on the nose end 26 of the piston 16 for retention of the second end 24 of the cantilever spring 20. As best shown in FIGS. 1 and 3, the cantilever spring 20 can include a hooked end 34 at the second end 24 of the cantilever spring 20. The cantilever spring 20 can include a flat bar, wire, or cross-sectional spring material. The hooked end 34 can be engageable with the spring-retention groove 32 for securing the cantilever spring 20 to the nose end 26 of the piston 16. By way of example and not limitation, the cantilever spring 20 can engage the piston 16 via a pin-in-hole connection or other retention method. When the piston 16 is spring-loaded during shipment of the hydraulic tensioner 10, the piston 16 can be secured within the cylindrical aperture of the sleeve 14 by engagement of the cantilever spring 20 with the piston 16. It should be recognized by those skilled in the art that the first and/or second ends 22, 24 interfacing between the cantilever spring 20 and the piston 16, and/or the cantilever spring 20 and the housing 12, could be modified to allow the cantilever spring 20 to be symmetrical with respect to the first end 22 and second end 24.

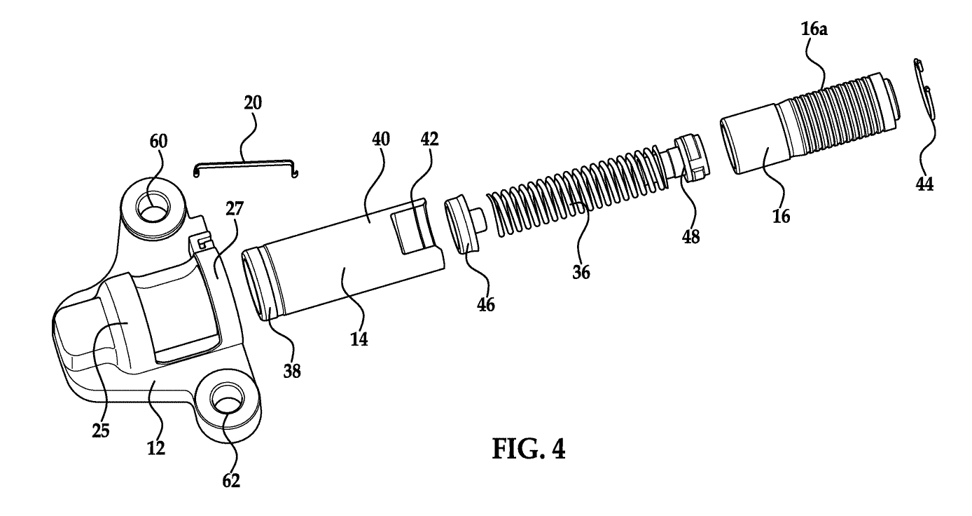

Referring now to FIGS. 3-4, a longitudinal cylindrical sleeve 14 can be supported by the housing 12 of the hydraulic tensioner 10. The cylindrical sleeve 14 can be secured to the housing 12. The cylindrical sleeve 14 can include a first end 38 located inwardly with respect to the housing 12 and a second end 40 located outwardly with respect to the housing 12. The second end 40 can receive the piston 16 and allow for longitudinal movement of the piston 16 inwardly and outwardly within the cylindrical aperture defined by the sleeve 14 with respect to the housing 12. It should be recognized by those skilled in the art that the shape of the housing 12 supporting the cylindrical sleeve 14 can be modified. The housing 12 can include bolt apertures 60, 62 for attaching the hydraulic tensioner 10 to an engine. The housing 12 can include a seat portion 25 enclosing a fluid passage 39. The housing 12 can include a support band 27 for retaining the cylindrical sleeve 14 when the cylindrical sleeve 14 is seated with respect to the seat portion 25. The cylindrical sleeve 14 can define a notch or window 42 located at the second end 40 with spaced side walls 42a, 42b. As best seen in FIGS. 1, 3 and 4, the hydraulic tensioner 10 can include a snap ring 44 fixed to an outer circumference of the piston 16 and selectively engageable within one of the plurality of grooves 16a formed on an external surface of the piston 16. As best seen in FIG. 3, the snap ring 44 can have at least one projection 50, 52 extending radially outwardly with respect to the piston 16 and engageable within the window 42. The side walls 42a, 42b of the window 42 allow the outer ends 50, 52 of the snap ring 44 to expand slightly as increased hydraulic fluid pressure within the expandable fluid chamber ratchets the piston 16 outwardly in response to gradual elongation and wear of the endless loop power transmission member, corresponding to reduced back pressure from the endless loop power transmission member on the piston 16, thereby moving the snap ring 44 from one groove 16a to another groove 16a of the piston 16 as the piston 16 extends outwardly from the cylindrical aperture of the housing to maintain a desired pressure on the endless loop power transmission member. As best seen in FIG. 1, the cylindrical sleeve 14 includes an inner annular groove having sidewalls 14a, 14b for receiving the snap ring 44 and for limiting longitudinal movement of the piston 16 within the cylindrical aperture of the housing 12 when back pressure from the endless loop power transmission member is substantially balanced with fluid pressure within the expandable fluid chamber of the hydraulic tensioner. Elongation of the endless loop power transmission member reduces back pressure from the endless loop power transmission member on the piston 16, and allows the hydraulic fluid pressure within the expandable fluid chamber of the housing 12 to ratchet the piston 16 outwardly driving the snap ring 44 into another groove 16a of the piston 16 extending the piston 16 to an incrementally expanded outwardly extended position.

As best shown in FIGS. 1 and 4, the hydraulic tensioner 10 can include at least one check valve 46, 48 received within the cylindrical aperture of the sleeve 14. The tensioner spring 36 can be interposed between a first check valve 46 and a second check valve 48 within the cylindrical sleeve 14. The tensioner spring 36 biases the piston 16 in an outward direction from the cylindrical aperture of the sleeve 14. The first check valve 46 prevents back flow of the hydraulic fluid out of the expandable chamber of the housing 12, thereby preventing inward movement of the piston 16 beyond the degree allowed by the interaction of snap ring 44 with the side wall 14b of the sleeve 14. The second check valve 48 allows intermittent lubrication of the endless loop power transmission member as the piston 16 is “pumped” between the extended and retracted positions during longitudinal movement of the snap ring 44 between the end limits of travel defined by the side walls 14a, 14b of the inner annular groove of the sleeve 14.

In operation, the piston 16 can be assembled within the hydraulic tensioner 10 for storage and shipping of the hydraulic tensioner 10 prior to installation of the hydraulic tensioner 10 into a working environment. When the piston 16 is positioned for shipping, the hooked end 34 formed at the second end 24 of the cantilever spring 20 can engage the spring-retention groove 32 in response to applied force against the cantilever spring 20 towards the piston 16. The second end 24 of the cantilever spring 20 can move relative to the first end 22 of the cantilever spring 20 fixed to the housing 12. The spring-retention groove 32 can retain the hooked end 34 formed at the second end 24 for securing the cantilever spring 20 to the nose end 26 of the piston 16 and retaining the piston 16 when the piston 16 is spring-loaded by the tensioner spring 36 during assembly to prepare the assembled hydraulic tensioner 10 for shipment. After installation of the hydraulic tensioner 10 into a working environment, by way of example and not limitation, such as an internal combustion engine, an electric engine drive train, or a hybrid drive train, force can be applied against the piston 16 such that the piston 16 can move inwardly with respect to the housing 12. The hooked end 34 can disengage the spring-retention groove 32 in response to the applied force against the piston 16. The piston 16 can then be released for longitudinal movement outwardly toward an extended position with respect to the cylindrical sleeve 14 of the housing 12 for normal operation of the hydraulic tensioner 10 within the working environment. The second end 24 of the cantilever spring 20 can move away from the piston 16 towards a non-tensioned state. The cantilever spring 20 can be in a non-tensioned state and disengaged from the piston 16 during operation within the working environment. By way of example and not limitation, the first end 22 of the cantilever spring 20 can remain fixed to the housing 12 during operation within the working environment such that the hydraulic tensioner 10 can be reset during a service application by re-engaging the cantilever spring 20 with the spring-retention groove 32 in the nose 26 of the piston 16.

A hydraulic tensioner 10 for an endless loop power transmission member can be assembled for storage and shipment. The hydraulic tensioner 10 can include a housing 12 having a cylindrical aperture. The method for assembling the hydraulic tensioner 10 can include mounting a sleeve 14 having a cylindrical aperture to the housing 12, inserting a tensioner spring 36 into the cylindrical sleeve 14, inserting a slideable tensioning piston 16 into the cylindrical sleeve 14 for movement between an extended position and a retracted position, and attaching a cantilever spring 20 to the housing 12. A fluid chamber can be defined between the cylindrical sleeve 14 of the housing 12 and the piston 16 and the piston can be spring-loadable by the tensioner spring 36. The cantilever spring 20 can have a first end 22 attachable to the housing 12 and a second end 24 releasably engageable with the piston 16 for retaining the piston 16 within the hydraulic tensioner 10 against urgings of the tensioner spring 36 during storage and shipment. The second end 24 of the cantilever spring 20 can be disengageable with the piston 16 allowing movement of the piston 16 outwardly with respect to the housing 12. The method can further include forming a spring receiving slot 30 in the housing 12 for receiving the first end 22 of the cantilever spring. The method can further include forming a spring-retention groove 32 on a nose end 26 of the piston and engaging a hooked end 34 located at the second end 24 of the cantilever spring 20 with the spring-retention groove 32. The hooked end 34 can engage the spring-retention groove for securing the cantilever spring 20 to the nose end 26 of the piston 16 and retaining the piston 16 against the urging of the tensioner spring 36. The hooked end 34 can engage the spring-retention groove 32 in response to force applied against the cantilever spring 20 by the tensioner spring 36 through the piston 16. The method can further include applying force against the piston 16 to move the piston 16 inwardly with respect to the housing 12 and disengaging the hooked end 34 with respect to the spring-retention groove 32 in response to the force applied. The piston 16 can be operable for movement outwardly with respect to the housing 12 and the cantilever spring 20 in a non-tensioned state during operation within a working environment.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

1. In a hydraulic tensioner (10) for an endless loop power transmission member, the hydraulic tensioner (10) including a housing (12) having an aperture and a piston (16) slidably received within the aperture for movement between an extended position and a retracted position, a tensioner spring (36) biasing the piston (16) toward the extended position with respect to the aperture, the piston (16) and the aperture of the housing (12) defining a fluid chamber (18), the improvement of the hydraulic tensioner (10) comprising:
a cantilever spring (20) having a first end (22) attachable to the housing (12) and a second end (24) releasably engageable with the piston (16) for retaining the piston (16) in the retracted position within the aperture of the housing (12) against an urging of the tensioner spring (36), the second end (24) of the cantilever spring (20) disengageable from the piston (16) allowing movement of the piston (16) outwardly toward the extended position with respect to the aperture of the housing (12).

2. The improvement of claim 1 further comprising:
the housing (12) having a spring-receiving slot (30) formed therein for receiving the first end (22) of the cantilever spring (20).

3. The improvement of claim 1 further comprising:
the piston (16) having a spring-retention groove (32) formed on a nose end (26) of the piston (16); and
the cantilever spring (20) having a hooked end (34) formed at the second end (24) of the cantilever spring (20) engageable with the spring-retention groove (32) for securing the cantilever spring (20) to the nose end (26) of the piston (16) and retaining the piston (16) within the aperture of the housing (12).

4. The improvement of claim 3, wherein the hooked end (34) engages the spring-retention groove (32) in response to force applied against the cantilever spring (20) towards the piston (16), the hooked end (34) disengaging the spring-retention groove (32) in response to force applied against the piston (16) and the piston (16) moving inwardly with respect to the housing (12).

5. The improvement of claim 4, wherein the cantilever spring (20) is in a non-tensioned state during operation in a working environment.

6. The improvement of claim 3, wherein the hooked end (34) is engaged with the spring-retention groove (32) during storage, shipping and installation of the hydraulic tensioner (10), the hooked end (34) disengaged with the spring-retention groove (32) after installation of the hydraulic tensioner (10) and during operation in a working environment.

7. The improvement of claim 1, wherein the tensioner spring (36) further comprises:
the tensioner spring (36) received in the aperture of the housing (12) and engageable between the piston (16) and the housing (12) for spring-loading the piston (16).

8. A hydraulic tensioner (10) comprising:
a housing (12) having a hollow longitudinal sleeve (14), the housing (12) defining a fluid passage in fluid communication with an interior aperture of the hollow longitudinal sleeve (14);
a piston (16) received in the aperture of the hollow longitudinal sleeve (14) for longitudinal movement between an extended position and a retracted position, the piston (16) and hollow longitudinal sleeve (14) defining an expandable fluid chamber between the housing (12) and the piston (16), the piston (16) having a spring-retention groove (32) formed on a nose end (26) of the piston (16);
a tensioner spring (36) within the aperture of the hollow longitudinal sleeve (14) biasing the piston (16) toward the extended position with respect to the hollow longitudinal sleeve (14); and
a cantilever spring (20) attachable to the housing (12), the cantilever spring (20) having a first end (22) attachable to the housing (4012) and a second end (24) releasably engageable with the spring-retention groove (32) of the piston (16) for retaining the piston (16) within the hollow longitudinal sleeve (14), the second end (24) of the cantilever spring (20) disengageable with the spring-retention groove (32) allowing longitudinal movement of the piston (16) outwardly with respect to the housing (12) when operating in a working environment.

9. The hydraulic tensioner (10) of claim 8, wherein the cantilever spring (20) further comprises:
a hooked end (34) located at the second end (24) of the cantilever spring (20) engageable with the spring-retention groove (32) for securing the cantilever spring (20) to the nose end (26) of the piston (16) and retaining the piston (16) within the aperture of the hollow longitudinal sleeve (14) when the piston (16) is spring-loaded.

10. The hydraulic tensioner (10) of claim 9, wherein the hooked end (34) engages the spring-retention groove (32) in response to force applied against the cantilever spring (20) by the tensioner spring (36) through the piston (16), the hooked end (34) disengaging the spring-retention groove (32) in response to force applied against the piston (16) such that the piston (16) moves inwardly with respect to the housing (12).

11. The hydraulic tensioner (10) of claim 8, wherein the tensioner spring (36) further comprises:
the tensioner spring (36) received within the aperture of the hollow longitudinal sleeve (14) and engageable between the piston (16) for spring-loading the piston (16); and
the housing (12) having an end defining a fluid passage (39) in fluid communication with the expandable fluid chamber of the housing (12).

12. A method for assembling a hydraulic tensioner (10) for an endless loop power transmission member, the method comprising:
connecting a hollow longitudinal sleeve (14) with respect to a housing (12) to define an aperture in fluid communication with a fluid passage (39);
inserting a tensioner spring (36) into the aperture of the hollow longitudinal sleeve (14);
inserting a slideable piston (16) into the aperture of the hollow longitudinal sleeve (14) for movement between an extended position and a retracted position to define an expandable fluid chamber between the housing (12), hollow longitudinal sleeve (14) and the piston (16), the piston (16) biased by the tensioner spring (36) toward the extended position; and
attaching a cantilever spring (20) to the housing (12), the cantilever spring (20) having a first end (22) attachable to the housing (12) and a second end (24) releasably engageable with the piston (16) for retaining the piston (16) within the aperture of the hollow longitudinal sleeve (14) of housing (12) against urging of the tensioner spring (36), the second end (24) of the cantilever spring (20) disengageable with the piston (16) allowing movement of the piston (16) outwardly with respect to the housing (12) during operation in a working environment.

13. The method of claim 12 further comprising:
forming a spring receiving slot (30) in the housing (12) for receiving the first end (22) of the cantilever spring.

14. The method of claim 13 further comprising:
forming a spring-retention groove (32) on a nose end (26) of the piston; and
engaging a hooked end (34) located at the second end (24) of the cantilever spring (20) with the spring-retention groove (32) for securing the cantilever spring (20) to the nose end (26) of the piston (16) and retaining the piston (16) against urgings of the tensioner spring (36), the hooked end (34) engaging the spring-retention groove (32) in response to force applied against the cantilever spring (20) by the tensioner spring (36) through the piston (16).

15. The method of claim 14 further comprising:
applying force against the piston (16) to move the piston (16) inwardly with respect to the housing (12); and
disengaging the hooked end (34) with respect to the spring-retention groove (32) in response to the applied force, the piston (16) operable for movement outwardly with respect to the housing (12) and the cantilever spring (20) in a non-tensioned state during operation in a working environment.
